(19) United States
(12) Patent Application Publication
(10) Pub. No.: US 2025/0236184 A1
(43) Pub. Date: Jul. 24, 2025

(54) VEHICLE AND CORRESPONDING FUEL CELL STARTUP CONTROL SYSTEM

(71) Applicant: FORD GLOBAL TECHNOLOGIES, LLC, Dearborn, MI (US)

(72) Inventors: Matthew RILEY, Ann Arbor, MI (US); Jason MEYER, Canton, MI (US); Nicholas B. CHASE, Royal Oak, MI (US); Hao WANG, Ann Arbor, MI (US)

(21) Appl. No.: 18/418,636

(22) Filed: Jan. 22, 2024

(51) Int. Cl. B60L 50/75; B60L 53/16; B60L 53/54; B60L 55/00; B60L 58/31; B60L 58/34

(52) U.S. Cl. CPC B60L 50/75; B60L 53/16; B60L 53/54; B60L 55/00; B60L 58/31; B60L 58/34

(57) ABSTRACT

A vehicle includes a battery, a fuel cell, an electrical connector, and a controller. The battery is configured to store electrical power. The fuel cell is configured to generate electrical power. The electrical connector is configured to connect the battery to an external source. The controller is programmed to, in response to, (i) a temperature of the fuel cell being less than a threshold and (ii) the electrical connector being connected to the external source, (a) operate the fuel cell at a power output to increase the temperature of the fuel cell and (b) deliver power generated by the fuel cell to the external source.

### STATEMENT REGARDING FEDERALLY SPONSORED RESEARCH OR DEVELOPMENT

The present disclosure was made with Government support under Contract No. DE-EE0009858 awarded by the Department of Energy (DOE). The Government has certain rights to the present disclosure.

### TECHNICAL FIELD

The present disclosure relates to vehicles having fuel cells.

### BACKGROUND

Vehicles may include fuel cell systems that generate electrical power.

### SUMMARY

A vehicle includes an electric machine, a battery, a fuel cell, an electrical connector, and a controller. The electric machine is configured to propel the vehicle. The battery is configured to provide electrical power to the electric machine. The fuel cell is configured to provide electrical power to the electric machine. The electrical connector is configured to connect the battery to an external source to charge the battery. The controller is programmed to, in response to, (i) initiating a vehicle start sequence, (ii) a temperature of the fuel cell being less than a threshold, and (iii) the electrical connector being connected to the external source, (a) operate the fuel cell at a power output to increase the temperature of the fuel cell, (b) limit delivery of electrical power from the fuel cell to the electric machine to less than a commanded value, and (c) deliver power generated by the fuel cell to the external source.

A vehicle includes an electric machine, a battery, a fuel cell, an electrical connector, and a controller. The electric machine is configured to propel the vehicle. The battery is configured to provide electrical power to the electric machine. The fuel cell is configured to provide electrical power to the electric machine. The electrical connector is configured to engage and disengage a mating connector to connect and disconnect the battery to and from an external source, respectively. The controller is programmed to, in response to, (i) starting the vehicle, (ii) a temperature of the fuel cell being less than a first threshold, and (iii) the electrical connector engaging the mating connector, (a) operate the fuel cell at a first power output to increase the temperature of the fuel cell. The controller is further programmed to, in response to, (i) starting the vehicle, (ii) the temperature of the fuel cell being less than the first threshold, (iii) the electrical connector being disengaged from the mating connector, and (iv) a charging capacity of the battery being greater than a second threshold, operate the fuel cell at a second power output that is less than the power output to increase the temperature of the fuel cell.

A vehicle includes a battery, a fuel cell, an electrical connector, and a controller. The battery is configured to store electrical power. The fuel cell is configured to generate electrical power. The electrical connector is configured to connect the battery to an external source. The controller is programmed to, in response to, (i) a temperature of the fuel cell being less than a threshold and (ii) the electrical connector being connected to the external source, (a) operate the fuel cell at a power output to increase the temperature of the fuel cell and (b) deliver power generated by the fuel cell to the external source.

### BRIEF DESCRIPTION OF THE DRAWINGS

FIG. 1 is a schematic diagram representative of a fuel cell system;

FIG. 2 is a schematic diagram representative of a vehicle that includes the fuel cell system; and

FIG. 3 is a flowchart illustrating a method for controlling the fuel cell during a startup.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

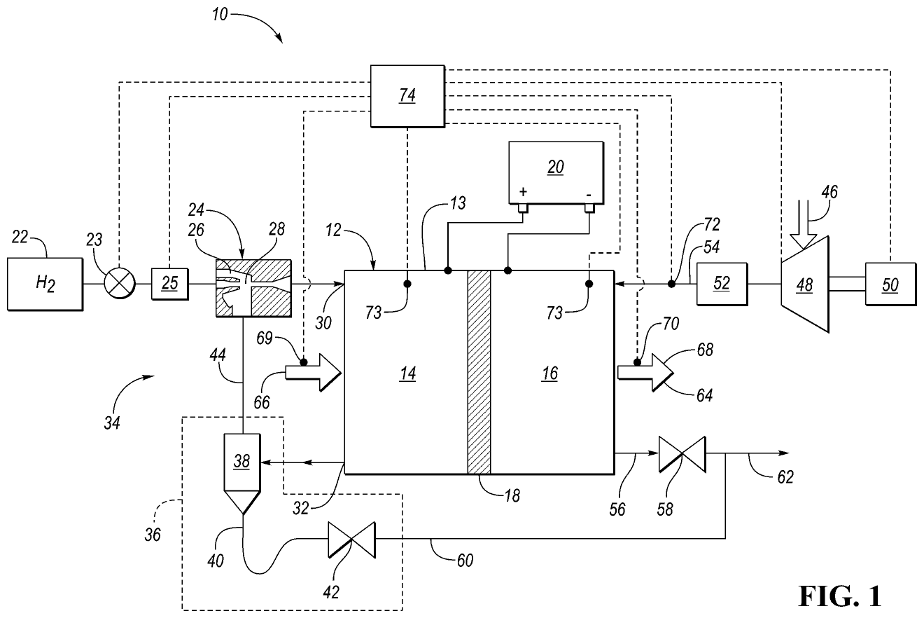

FIG. 1 schematically illustrates a fuel cell system (“the system”) 10 as a process flow diagram according to at least one embodiment. For example, system 10 may be used in a vehicle to provide electrical power to operate an electric motor to propel the vehicle or perform other vehicle functions. The system 10 may be implemented in a fuel cell based electric vehicle or a fuel cell based hybrid vehicle or any other such apparatus that uses electrical current to drive various devices.

The system 10 has a fuel cell stack (“the stack”) 12. The stack 12 includes multiple cells, with each cell 13 having an anode side 14 (including an anode catalyst), a cathode side 16 (including a cathode catalyst), and a membrane 18 between the anode and cathode catalyst. Only one fuel cell 13 of the fuel cell stack 12 is illustrated in FIG. 1, although the stack 12 contains any number of cells. The stack 12 electrically communicates with and provides energy, for example, to a high voltage bus or a traction battery 20. The stack 12 generates stack current in response to electrochemically converting hydrogen and oxygen. The stack 12 may also have a cooling loop (not shown).

Various electrical devices may be coupled to the battery 20 to consume such power in order to operate. If the system 10 is used in connection with a vehicle, the devices may include a motor or a plurality of vehicle electrical components that each consume power to function for a particular purpose. For example, such devices may be associated with and not limited to a vehicle powertrain, cabin heating and cooling, interior/exterior lighting, entertainment devices, and power locking windows. The particular types of devices implemented in the vehicle may vary based on vehicle content, the type of motor used, and the particular type of fuel cell stack implemented.

During operation of the system 10, product water, residual fuel such as hydrogen, and byproducts such as nitrogen, may accumulate at the anode side 14 of the stack 12. Attempts have been made to remove the liquid product water and byproducts and to reuse the residual hydrogen and at least a portion of the water vapor. One approach is to collect those constituents in a purge assembly 36 downstream of the stack 12, separate at least a portion of the liquid water, and return the remaining constituents to the stack 12 via a return passageway in a recirculation loop.

A primary fuel source 22 is connected to the anode side 14 of the stack 12, such as a primary hydrogen source, to provide a supply fuel stream (or an anode stream). Non-limiting examples of the primary hydrogen source 22 are a high-pressure hydrogen storage tank or a hydride storage device. For example, liquid hydrogen, hydrogen stored in various chemicals such as sodium borohydride or alanates, or hydrogen stored in metal hydrides may be used instead of compressed gas. A tank valve 23 controls the flow of the supply hydrogen. A pressure regulator 25 may be included to regulate the flow of the supply hydrogen. The tank valve 23 may also be referred to as an inlet valve or an injection valve. The tank valve 23 is configured open to deliver the hydrogen to the anode side 14 and close to restrict hydrogen from flowing into the anode side 14.

The hydrogen source 22 is connected to one or more ejectors 24. The ejector may be a variable or multistage ejector or other suitable ejector. The ejector 24 is configured to combine the supply hydrogen (e.g., hydrogen received from the source 22) with unused hydrogen (e.g., recirculated from the fuel cell stack 12) to generate an input fuel stream. The ejector 24 controls the flow of the input fuel stream to the stack 12. The ejector 24 has a nozzle 26 supplying hydrogen into the converging section of a converging-diverging nozzle 28. The diverging section of the nozzle 28 is connected to the input 30 of the anode side 14.

The output 32 of the anode side 14 is connected to a recirculation loop 34. The recirculation loop 34 may be a passive recirculation loop, as shown, or may be an active recirculation loop according to another embodiment. Typically, an excess of hydrogen gas is provided to the anode side 14 to ensure that there is sufficient hydrogen available to all of the cells in the stack 12. In other words, under normal operating conditions, hydrogen is provided to the fuel cell stack 12 above a stoichiometric ratio of one, i.e. at a fuel-rich ratio relative to exact electrochemical needs. The unused fuel stream, or recirculated fuel stream, at the anode output 32 may include various impurities such as nitrogen and water both in liquid and vapor form in addition to hydrogen. The recirculation loop 34 is provided such that excess hydrogen unused by the anode side 14 is returned to the input 30 so it may be used and not wasted.

Accumulated liquid and vapor phase water is an output of the anode side 14. The anode side 14 requires humidification for efficient chemical conversion and to extend membrane life. The recirculation loop 34 may be used to provide water to humidify the supply hydrogen gas before the input 30 of the anode side 14. Alternatively, a humidifier may be provided to add water vapor to the input fuel stream.

The recirculation loop 34 contains a purging assembly 36 to remove impurities or byproducts such as excess nitrogen, liquid water, and/or water vapor from the recirculation stream. The purging assembly 36 includes a water separator or knock-out device 38, a drain line 40 and a control valve 42, such as a purge valve. The separator 38 receives a stream or fluid mixture of hydrogen gas, nitrogen gas, and water from the output 32 of the anode side 14. The water may be mixed phase and contain both liquid and vapor phase water. The separator 38 removes at least a portion of the liquid phase water, which exits the separator through drain line 40. At least a portion of the nitrogen gas, hydrogen gas, and vapor phase water may also exit the drain line 40, and pass through a control valve 42, for example, during a purge process of the fuel cell stack 12. The control valve 42 may be a solenoid valve or other suitable valve. The remainder of the fluid in the separator 38 exits through passageway 44 in the recirculation loop 34, which is connected to the ejector 24, as shown, or an active anode recirculation rotary device. The stream in passageway 44 may contain a substantial amount of hydrogen compared to the stream in drain line 40. The fluid in passageway 44 is fed into the converging section of the converging-diverging nozzle 28 where it mixes with incoming hydrogen from the nozzle 26 and hydrogen source 22.

The cathode side 16 of the stack 12 receives oxygen in a cathode stream, for example, as a constituent in an air source 46 such as atmospheric air. In one embodiment, a compressor 48 is driven by a motor 50 to pressurize the incoming air. The pressurized air, or cathode stream, may be humidified by a humidifier 52 before entering the cathode side 16 at inlet 54. The water may be needed to ensure that membranes 18 for each cell 13 remain humidified to provide for optimal operation of the stack 12. The output 56 of the cathode side 16 is configured to discharge excess air and is connected to a valve 58. Drain line 60 from the purging assembly 36, may be connected to an outlet 62 downstream of the valve 58. In other embodiments, the drain lines may be plumbed to other locations in the system 10.

The stack 12 may be cooled using a coolant loop 64 as is known in the art. The coolant loop 64 has an inlet 66 and an outlet 68 to the stack 12 to cool the stack. The coolant loop 64 may have temperature sensors 69 and 70, which are used to determine the temperatures of the coolant at the inlet and the outlet of the stack 12, respectively. One or the other or a combination of both of the coolant temperatures (e.g., the coolant temperatures at the inlet and the outlet) may correspond to a temperature of the stack 12 or a separate sensor may be used to determine the temperature of the stack 12, which may be communicated to the controller (74).

The stack 12 may also have a humidity sensor 72 positioned at the inlet 54 to the cathode side 16 of the stack 12. The sensor 72 may also include a temperature sensing module. Pressure sensors 73 may be utilized to determine the respective pressures within the anode side 14 of the stack 12 and the cathode side 16 of the stack 12. Temperature sensors (not shown) may also be utilized to determine the respective temperature within the anode side 14 of the stack 12 and the cathode side 16 of the stack 12.

A controller 74 receives signals from the sensors 69, 70, 72, 73, and any other sensor that may be associated with the fuel cell system 10. The controller 74 may be a single controller or multiple controllers in communication with one another. The controller 74 may also be in communication with the valve 23, regulator 25, valve 42, valve 58, compressor 48, and motor 50.

During operation, the stoichiometric ratio of total reactant per reactant electrochemically needed for both reactants of the fuel cell system may be controlled based on the fuel cell operating state, environmental conditions, and the like. The stoichiometry may be controlled by using the valve 23 and regulator 25 on the anode side 14 to control the flow rate of fuel or hydrogen to the stack 12, and by using the compressor 48 and motor 50 on the cathode side 16 to control the flow rate of air to the stack 12. The system 10 may be operated through a range of fuel and air stoichiometric ratios. As the system 10 is operated at a lower power level, the amount of water byproduct will decrease, as the amount of current drawn from the stack 12 decreases.

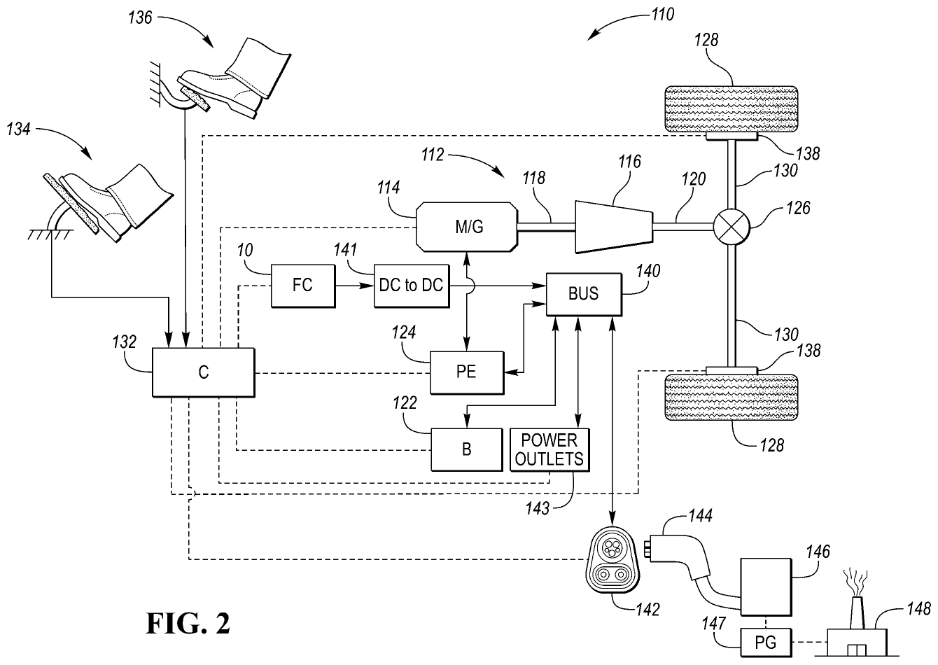

Referring to FIG. 2, a schematic diagram of an electric or hybrid vehicle 110 is illustrated according to an embodiment of the present disclosure. FIG. 2 illustrates representative relationships among the components. Physical placement and orientation of the components within the vehicle 110 may vary. The vehicle 110 includes a powertrain 112. The powertrain 112 includes an electric machine such as an electric motor/generator (M/G) 114 that drives a transmission (or gearbox) 116. More specifically, the M/G 114 may be rotatably connected to an input shaft 118 of the transmission 116. The transmission 116 may be placed in PRNDSL (park, reverse, neutral, drive, sport, low) via a transmission range selector (not shown). The transmission 116 may have a fixed gearing relationship that provides a single gear ratio between the input shaft 118 and an output shaft 120 of the transmission 116. A torque converter (not shown) or a launch clutch (not shown) may be disposed between the M/G 114 and the transmission 116. Alternatively, the transmission 116 may be a multiple step-ratio automatic transmission. An associated traction battery 122 is configured to deliver electrical power to or receive electrical power from the M/G 114. Battery 122 may also correspond to battery 20 depicted in FIG. 1.

The M/G 114 is a drive source for the vehicle 110 that is configured to propel the vehicle 110. The M/G 114 may be implemented by any one of a plurality of types of electric machines. For example, M/G 114 may be a permanent magnet synchronous motor. Power electronics 124 condition direct current (DC) power provided by the battery 122 or the fuel cell system 10 to the requirements of the M/G 114, as will be described below. For example, the power electronics 124 may provide three phase alternating current (AC) to the M/G 114.

If the transmission 116 is a multiple step-ratio automatic transmission, the transmission 116 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 120 and the transmission input shaft 118. The transmission 116 is automatically shifted from one ratio to another based on various vehicle and ambient operating conditions by an associated controller, such as a powertrain control unit (PCU). Power and torque from the M/G 114 may be delivered to and received by transmission 116. The transmission 116 then provides powertrain output power and torque to output shaft 120.

It should be understood that the hydraulically controlled transmission 116, which may be coupled with a torque converter (not shown), is but one example of a gearbox or transmission arrangement; any multiple ratio gearbox that accepts input torque(s) from a power source (e.g., M/G 114) and then provides torque to an output shaft (e.g., output shaft 120) at the different ratios is acceptable for use with embodiments of the present disclosure. For example, the transmission 116 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 2, the output shaft 120 is connected to a differential 126. The differential 126 drives a pair of drive wheels 128 via respective half shafts or axles 130 connected to the differential 126. The differential 126 transmits approximately equal torque to each wheel 128 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 112 further includes an associated controller 132 such as a powertrain control unit (PCU). While illustrated as one controller, the controller 132 may be part of a larger control system and may be controlled by various other controllers throughout the vehicle 110, such as a vehicle system controller (VSC). It should therefore be understood that the powertrain control unit 132 and one or more other controllers can collectively be referred to as a “controller” that controls various actuators in response to signals from various sensors to control functions such as operating the M/G 114 to provide wheel torque or charge the battery 122, select or schedule transmission shifts, etc. Controller 132 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller in controlling the vehicle 110.

The controller 132 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 2, controller 132 may communicate signals to and/or receive signals from the fuel cell system 10, M/G 114, battery 122, transmission 116, power electronics 124, and any another component of the powertrain 112 that may be included, but is not shown in FIG. 2 (e.g., a launch clutch that may be disposed between the M/G 114 and the transmission 116). Although not explicitly illustrated, those of ordinary skill in the art will recognize various functions or components that may be controlled by controller 132 within each of the subsystems identified above. Representative examples of parameters, systems, and/or components that may be directly or indirectly actuated using control logic and/or algorithms executed by the controller 132 include front-end accessory drive (FEAD) components such as an alternator, air conditioning compressor, battery charging or discharging, regenerative braking, M/G 114 operation, clutch pressures for the transmission gearbox 116 or any other clutch that is part of the powertrain 112, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor), transmission gear, ratio, or mode, transmission oil temperature (TOT), transmission input and output speed, deceleration or shift mode (MDE), battery temperature, voltage, current, or state of charge (SOC) for example.

Control logic or functions performed by controller 132 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle and/or powertrain controller, such as controller 132. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 134 is used by the driver of the vehicle 110 to provide a demanded torque, power, or drive command to the powertrain 112 (or more specifically M/G 114) to propel the vehicle. In general, depressing and releasing the accelerator pedal 134 generates an accelerator pedal position signal that may be interpreted by the controller 132 as a demand for increased power or decreased power, respectively. A brake pedal 136 is also used by the driver of the vehicle to provide a demanded braking torque to slow the vehicle. In general, depressing and releasing the brake pedal 136 generates a brake pedal position signal that may be interpreted by the controller 132 as a demand to decrease the vehicle speed. Based upon inputs from the accelerator pedal 134 and brake pedal 136, the controller 132 commands the torque and/or power to the M/G 114, and friction brakes 138. The controller 132 also controls the timing of gear shifts within the transmission 116.

The M/G 114 may act as a motor and provide a driving force for the powertrain 112. To drive the vehicle with the M/G 114 the traction battery 122 transmits stored electrical energy or power to the power electronics 124 that may include inverter and rectifier circuitry, for example. In addition, or in lieu of the battery 122, the fuel cell system 10 may transmit the electrical energy or power generated by the fuel cell system 10 to the power electronics 124. The inverter circuitry of the power electronics 124 may then convert DC voltage from the battery 122 and/or the fuel cell system 10 into AC voltage to be used by the M/G 114. The rectifier circuitry of the power electronics 124 may convert AC voltage from the M/G 114 into DC voltage to be stored with the battery 122 or to be used for other purposes (e.g., to power an auxiliary load). The controller 132 commands the power electronics 124 to convert voltage from the battery 122 and/or the fuel cell system 10 to an AC voltage provided to the M/G 114 to provide positive or negative torque to the input shaft 118.

The M/G 114 may also act as a generator and convert kinetic energy from the powertrain 112 into electric energy to be stored in the battery 122. More specifically, the M/G 114 may act as a generator during times of regenerative braking in which torque and rotational (or kinetic) energy from the spinning wheels 128 is transferred back through the transmission 116 and is converted into electrical energy for storage in the battery 122.

The battery 122 and the fuel cell system 10 may, more specifically, transmit the electrical energy to the power electronics 124 via a bus 140. The bus 140 may operate at a higher voltage (e.g., 100-800 Volts) relative to a lower voltage system (e.g., a 12 Volt system) of the vehicle 10 that delivers power to vehicle accessories such as the radio, headlamps, etc. Therefore, the bus 140 may be referred to as the high voltage bus. A DC to DC converter 141 may deliver electrical energy from the fuel cell system 10 to the bus 140. The DC to DC converter 141 may either increase or decease the voltage of the electric energy being delivered from the fuel cell system 10 to the bus 140.

The vehicle 110 may also include power outlets 143 that allow a user to connect external devices (e.g., power tools, lighting systems, handheld devices, etc.) to the powertrain 112 so that electrical power generated by the powertrain 112 (e.g., electrical power from the M/G 114, battery 122, fuel cell system 10, etc.) may be delivered from the powertrain 112 to the external devices. The power outlets 143 may be 120 Volt, 240 Volt, or any other desirable voltage that is compatible with the external devices being utilized. Electrical power may also be delivered to the powertrain 112 or subcomponents (e.g., the battery 122) via the power outlets 143 via external devices that are configured to generate or store electrical power (e.g., an external electrical generator or battery). The power outlets 143 are electrically connected to the powertrain 112 or subcomponents via the bus 140.

The vehicle 110 may be configured to receive power from an external power source to charge the battery 122. For example, the vehicle 110 may include an electrical port 142 that is configured to engage a connector head 144 of a charging station 146 to receive power from the charging station 146 to charge the battery 122. The electrical port 142 may also be referred to as a charging port or as an electrical connector. The connector head 144 may be referred to as mating electrical connector that is configured to mate with the electrical port 142. The charging station 146 may be connected to a power grid 147 that receives electrical power from a power plant 148. The power grid 147 may be or may include the power system of an adjacent building, such as a home, business, or office building. The electrical port 142 is electrically connected to the battery 122, and more broadly to the powertrain 112, via the bus 140. Power flow along the engagement between the electrical port 142 and the connector head 144 may be bi-directional. For example, power may flow from the power grid 147 to the vehicle 110 via the connection between the electrical port 142 and the connector head 144 or power may flow from the vehicle 110 to the power grid 147 via the connection between the electrical port 142 and the connector head 144.

Stated in broader terms, the electrical port 142 is configured to connect the battery 122 to an external power source (e.g., charging station 146, power grid 147, power system of an adjacent building, etc.). The electrical port 142 is also configured to engage and disengage the connector head 144 to connect and disconnect the battery 122 to and from such an external source, respectively.

It is noted that a single arrow connection between one of the components of the vehicle 110 and the bus 140 may represent a connection where electrical power only flows in only one direction (e.g., electric power may only flow from the bus 140 to the corresponding component or electric power may only flow from the corresponding component to the bus 140). It is further noted that a double arrow connection between one of the components of the vehicle 110 and the bus 140 may represent a connection where electrical power may flow in either direction (e.g., electric power may flow from the bus 140 to the corresponding component and electric power may flow from the corresponding component to the bus 140).

The controllers 74, 132 described herein, may be part of a larger control system and may be controlled by various other controllers throughout the vehicle 110 or fuel cell system 10, such as a vehicle system controller (VSC). It should therefore be understood that the controllers 74, 132, and one or more other controllers, can collectively be referred to as a “controller” that controls various actuators in response to signals from various sensors to control various functions of the vehicle 110 or fuel cell system 10. Such a controller may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller in controlling the vehicle 110 or fuel cell system 10.

It should be understood that the schematic illustrated in FIG. 2 is merely representative and is not intended to be limiting. Other configurations are contemplated without deviating from the scope of the disclosure. For example, the vehicle powertrain 112 may be configured to deliver power and torque to one or both of the front wheels as opposed to the illustrated rear wheels 128.

Startup of a fuel cell vehicle, after the vehicle has been off and exposed to freezing temperatures, may require a start or startup sequence that operates to warm the fuel cell system to desired temperatures. Operation of the fuel cell system to propel the vehicle may be limited during such a startup sequence. Once the fuel cell is sufficiently heated to desired operating temperatures, the fuel cell system can provide full power output for driving the vehicle. The fuel cell system also operates at an efficient state once the fuel cell temperature is above freezing.

Fuel cell systems generate electrical current by reacting reactants, namely fuel (such as for example hydrogen) electrochemically together with an oxidant (such as for example oxygen, usually from ambient air). Fuel cell systems conventionally comprise at least one fuel cell stack, which includes a plurality of fuel cells (often more than one hundred). Each fuel cell has a cathode area and an anode area, which are separated from one another by a membrane (for example a proton exchange membrane). The electrochemical process proceeds between these cathode or anode areas, and the efficiency of the electrochemical process is dependent on process conditions. One important process condition relates to the operating temperature of the fuel cells, since the electrochemical process proceeds with the greatest economic viability and maximum energy yield in an operating temperature at or above approx. 60° C.

A fuel cell vehicle with plugin charging capability also presents a unique battery charging challenge. For traditional plugin vehicles (e.g., battery electric vehicles or plug-in hybrid electric vehicles), the battery is charged as much as possible to maximize the usable energy of the battery. When charging is complete, the capability of the battery to receive additional energy or power is reduced. However, this is not a significant concern with battery electric vehicles or plug-in hybrid electric vehicles since battery electric vehicles or plug-in hybrid electric vehicles do not need to charge the battery while in operation. The most significant source of charging in battery electric vehicles or plug-in hybrid electric vehicles is regenerative braking. Friction brakes can be used instead of regenerative braking when the battery charging power limits are low (e.g., the ability of the battery to receive additional charge is low). During a freeze start of a fuel cell vehicle that also includes a battery, the fuel cell needs to produce electricity in order to obtain the desired operating temperatures. To ensure that the battery has enough charging power capability to accept power and additional charge from the fuel cell in a fuel cell vehicle, the battery charging controller would need to terminate charging well before the battery is fully charged when ambient temperatures are at or below 0° C. This is also not desirable, since having a lower battery charge will reduce the driving range of the vehicle. The solution described herein, provides a system that facilitates both maximizing battery charge and operation of the fuel cell by allowing the fuel cell to deliver power to one or more power sinks during a startup sequence.

In many cases the vehicle may be connected to the charge port in an outdoor environment and thus at times will experience a cold start. For fuel cell vehicles with bi-directional charge ports, it is proposed to institute a feature to send surplus electricity to a grid during the cold start and as utilities allow, the vehicle owner may receive a monetary benefit for that power supplied to the grid. The power sink available to the fuel cell would thus not be limited by only the available power sinks on the vehicle. The power sink available via the power grid is nearly unlimited and thus allows the warmup time of the fuel cell system to be minimized. Additional power sinks may also be available through external auxiliary loads such as devices connected to power outlets (e.g., power outlets 143) on the vehicle. Although, such auxiliary loads may be less of a power sink relative to a power grid, they still provide considerable margin to sink the power output during a fuel cell freeze startup (FSU) when the battery charging limit is low.

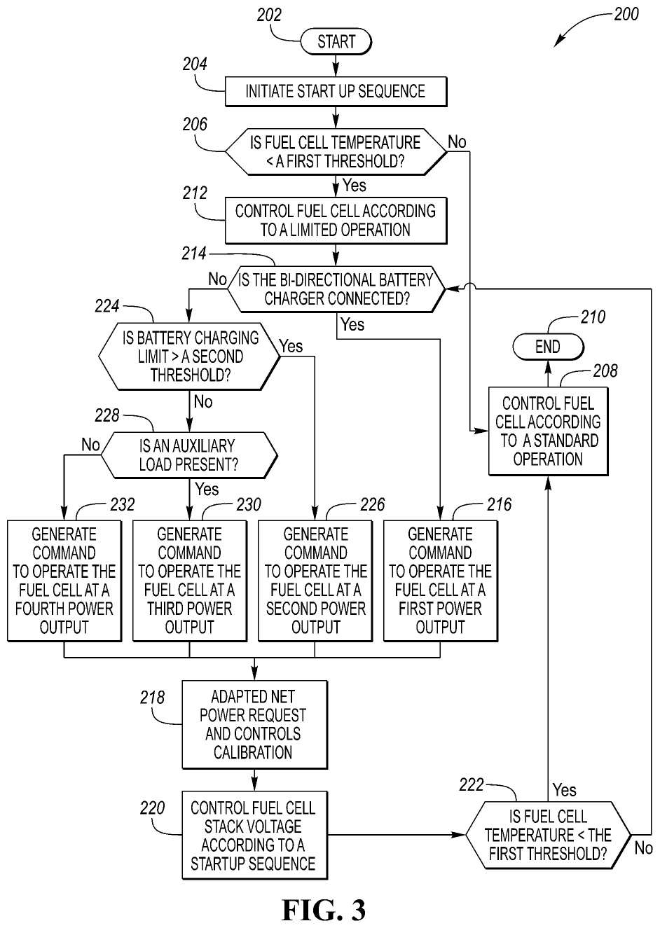

It is also proposed to use reactant depletion for inefficient operation only as much as is needed to limit water production. In this scenario it is not necessary to use reactant depletion for inefficient operation to limit electricity production since another power sink (the power grid) is available. A power output mode adaptation logic during an FSU for the fuel cell system is illustrated in FIG. 3. The power output mode adaptation is designed to handle the trade-offs among different power sink options in order to minimize the FSU time, the energy waste, and the stress on the high voltage traction battery when the battery is cold.

Specifically, there are four power output modes proposed with their differences explained as follows. The first mode may be referred to as a high-power output mode. The high- power output mode is enabled only when vehicle is on-plug (e.g., the electrical port 142 and the connector head 144 are engaged) and the vehicle has the authority to charge the power grid. Under the high-power output mode, FSU can be completed at its fastest rate without considering the battery charging limitations. However, the battery may still be charged or discharged depending on specific vehicle energy management strategy. The second mode may be referred to as the medium power output mode. The medium power output mode is enabled when battery charging limit is sufficiently high (e.g., the ability of the battery to receive charge is greater than a threshold), usually after battery has been pre-conditioned and the battery state-of-charge is below a threshold value. The third mode may be referred to as the low power output mode. The low power output mode is when battery charging limit is low (e.g., the ability of the battery to receive charge is less than the threshold) due to the battery temperature being low (e.g., below a threshold) and the battery state-of-charge being high (e.g., greater than a threshold), the available aux load and limited battery charging may be used to sink the power load from the fuel cell system during the FSU. The fourth mode may be referred to as the minimum power output mode. The minimum power output mode is slowest scenario that takes the longest time to heat the fuel cell during the FSU relative to the other modes described herein. When the vehicle is cold soaked in extreme temperature, without pre-conditioning on battery and with the availability of an external power sink, the fuel cell system must perform the FSU for pre-longed time under low efficiency operation.

Note that when each mode is selected, the corresponding power request and associated control calibrations will be set for the stack voltage-based FSU control strategy to handle the FSU process. While charging, the battery could be charged to as high a state-of-charge as possible even in cold conditions without having to worry about the battery charging power limits being high enough to accept the power produced by a subsequent fuel cell freeze start. This results in more EV capability and an increased vehicle driving range. Once the fuel cell completes the cold start, the owner would disconnect the charge line and may begin driving the vehicle.

The solution described herein provides several benefits. For example, when the customer knows that they want to drive the vehicle at a specific time in the future, they can leverage the grid power and charger to condition the battery, fuel cell and cabin, to eliminate the delay due to the cold start time. The warmup from grid power may be more cost effective than using hydrogen fuel. In case of an unscheduled customer startup, the start/warmup time is reduced relative to existing system and may consume less hydrogen when the power grid is available as a power sink. There is no need for added devices such as a large heater, but if a heater is equipped on the vehicle for other purposes, such an onboard coolant heater may be leveraged to heat the coolant to the fuel cell more effectively. The high voltage battery does not need to be artificially charged less in cold ambient conditions, which provides a more consistent range performance. Fuel use is directed towards producing useable electricity that the vehicle owner could sell to the utility companies, use to supply power to their own home or business, or use for other auxiliary loads.

Referring to FIG. 3, a flowchart of a method 200 for controlling the fuel cell system 10 and the vehicle 110 during a vehicle startup is illustrated. Additionally, the method 200 may be utilized during a fuel cell freeze startup (e.g., a startup of the fuel cell system 10 under cold or freezing conditions). A controller (e.g., controller 74 and/or controller 132) may implement the method 200 by controlling the various components of the fuel cell system 10 or vehicle 110. The method 200 begins at start block 202. Start block 202 may correspond to an engagement of a vehicle ignition or a “key on” condition that is indicative of an operator initiating a new drive cycle for operating the vehicle 110. Next, the method 200 moves on to block 204, where the startup sequence of the vehicle 110 and the fuel cell system 10 is initiated.

The method 200, then moves on to block 206 where it is determined if the temperature of the fuel cell system 10, or more specifically a temperature of a coolant that is configured to cool the stack 12, is less than a first threshold. The first threshold may be referred to as a temperature threshold. If the temperature of the fuel cell system 10, or more specifically the temperature of the coolant that is configured to cool the stack 12, is not less than the first threshold, the method 200 moves on to block 208, where the fuel cell system 10 is operated according to a standard or normal operation. The standard or normal operation may include delivering electrical power from the fuel cell 10 to either the M/G 114 (e.g., to propel the vehicle 110) or the battery 122 (e.g., to recharge the battery) via the bus 140 at desired or commanded values. The method 200 then moves on to block 210 where the startup sequence ends.

Returning to block 206, if the temperature of the fuel cell system 10, or more specifically the temperature of the coolant that is configured to cool the stack 12, is less than the first threshold, the method 200 moves on to block 212, where the fuel cell system 10 is operated according to a limited operation. The limited operation may include delivering electrical power from the fuel cell 10 to either the M/G 114 or the battery 122 at less than desired or commanded values. The method 200, next moves on to block 214 where it is determined if the bi-directional battery charger is connected (e.g., it is determined if the electrical port 142 and the connector head 144 engaged) or disconnected. It is noted that the step at block 212 may or may not be implemented depending on the magnitude of the desired or commanded values to deliver power from the fuel cell system 10 to either the M/G 114 or the battery 122 and the limits of the fuel cell system 10 to deliver power to either the M/G 114 or the battery 122 during the startup sequence. If the step at block 212 is not implemented, the method 200 may move on to block 214 directly from block 206.

If it is determined at block 214 that the battery charger is connected, the method 200 moves on to block 216 where a command or request to operate the fuel cell system 10 at a first power output level is generated in order to increase the temperature of the fuel cell system 10 during the startup sequence. Block 216 may correspond to the high-power output mode described above. The method 200, then moves on to block 218 where the power output command or request corresponding to the first power output level determined at block 216 is delivered to the fuel cell system 10. The controls to the fuel cell system 10 may also be calibrated or adjusted at block 218 to compensate for variation or changes in control parameters (e.g., the temperature of the fuel cell system 10, or more specifically a temperature of a coolant that is configured to cool the stack 12) during the startup sequence.

The voltage of the fuel cell stack 12 is then controlled according to a cold or freeze startup strategy at block 220 to generate power at the first power output level where the power is delivered to an external source (e.g., charging station 146, power grid 147, power system of an adjacent building, etc.) through the battery charger connection (e.g., the connection between the electrical port 142 and the connector head 144). Under this scenario, the external source operates as a power sink for the fuel cell system 10 during the start sequence where the fuel cell system 10 is being heated to desired operating temperatures. Such a cold or freeze startup strategy for controlling a fuel cell stack voltage during a startup sequence is described in U.S. patent application Ser. No. 18/348,604, filed on Jul. 7, 2023, which is incorporated by reference herein in its entirety.

The method 200 next moves on block 222, where it again is determined if the temperature of the fuel cell system 10, or more specifically a temperature of a coolant that is configured to cool the stack 12, is less than the first threshold. If the temperature of the fuel cell system 10, or more specifically the temperature of the coolant that is configured to cool the stack 12, is not less than the first threshold, the method 200 returns to block 214. If the temperature of the fuel cell system 10, or more specifically the temperature of the coolant that is configured to cool the stack 12, is less than the first threshold, the method 200 moves on to block 208, where the fuel cell system 10 is operated according to the standard or normal operation. The method 200 then moves on to block 210 where the startup sequence ends.

Returning to block 214, if it is determined that the battery charger is not connected (i.e., disconnected), the method 200 moves on to block 224 where it is determined if the charging limit or charging capacity of the battery 122 is greater than a second threshold. The second threshold may be referred to as the charging threshold. The charging limit or charging capacity of the battery 122 may correspond with the ability of the battery 122 to receive additional charge (e.g., a rate at which charge may be received by the battery 122 or a remaining capacity of the battery 122 to receive charge). The charging limit or charging capacity of the battery 122 may decrease as the overall charge of the battery 122 increases.

If the charging limit or charging capacity of the battery 122 is greater than the second threshold, the method 200 moves on to block 226 where a command or request to operate the fuel cell system 10 at a second power output level is generated in order to increase the temperature of the fuel cell system 10 during the startup sequence. The second power output level is less than the first power output level of block 216. Block 226 may correspond to the medium power output mode described above. The method 200, then moves on to block 218 where the power output command or request corresponding to the second power output level determined at block 226 is delivered to the fuel cell system 10. The voltage of the fuel cell stack 12 is then controlled according to a cold or freeze startup strategy at block 220 to generate power at the second power output level where the power is delivered to the battery 122. Under this scenario, the battery 122 operates as a power sink for the fuel cell system 10 during the start sequence where the fuel cell system 10 is being heated to desired operating temperatures.

The method 200 next moves on block 222, where it again is determined if the temperature of the fuel cell system 10, or more specifically a temperature of a coolant that is configured to cool the stack 12, is less than the first threshold. If the temperature of the fuel cell system 10, or more specifically the temperature of the coolant that is configured to cool the stack 12, is not less than the first threshold, the method 200 returns to block 214. If the temperature of the fuel cell system 10, or more specifically the temperature of the coolant that is configured to cool the stack 12, is less than the first threshold, the method 200 moves on to block 208, where the fuel cell system 10 is operated according to the standard or normal operation. The method 200 then moves on to block 210 where the startup sequence ends.

Returning to block 224, if the charging limit or charging capacity of the battery 122 is not greater than the second threshold, the method 200 moves on to block 228 where it is determined if an auxiliary load (e.g., devices connected to power outlets 143) is present or if there is a demand to deliver power to such an auxiliary load. If an auxiliary load is present or if there is a demand to deliver power to an auxiliary load, the method 200 moves on to block 230 where a command or request to operate the fuel cell system 10 at a third power output level is generated in order to increase the temperature of the fuel cell system 10 during the startup sequence. The third power output level is less than the second power output level of block 226. Block 230 may correspond to the low power output mode described above. The method 200, then moves on to block 218 where the power output command or request corresponding to the third power output level determined at block 230 is delivered to the fuel cell system 10. The voltage of the fuel cell stack 12 is then controlled according to a cold or freeze startup strategy at block 220 to generate power at the third power output level where the power is delivered to auxiliary load. Under this scenario, the auxiliary load operates as a power sink for the fuel cell system 10 during the start sequence where the fuel cell system 10 is being heated to desired operating temperatures.

The method 200 next moves on block 222, where it again is determined if the temperature of the fuel cell system 10, or more specifically a temperature of a coolant that is configured to cool the stack 12, is less than the first threshold. If the temperature of the fuel cell system 10, or more specifically the temperature of the coolant that is configured to cool the stack 12, is not less than the first threshold, the method 200 returns to block 214. If the temperature of the fuel cell system 10, or more specifically the temperature of the coolant that is configured to cool the stack 12, is less than the first threshold, the method 200 moves on to block 208, where the fuel cell system 10 is operated according to the standard or normal operation. The method 200 then moves on to block 210 where the startup sequence ends.

Returning to block 228, if an auxiliary load is not present (e.g., absent) and if there is no demand to deliver power to an auxiliary load, the method 200 moves on to block 232 where a command or request to operate the fuel cell system 10 at a fourth power output level is generated in order to increase the temperature of the fuel cell system 10 during the startup sequence. The fourth power output level is less than the third power output level of block 230. Block 232 may correspond to the minimum power output mode described above. The method 200, then moves on to block 218 where the power output command or request corresponding to the fourth power output level determined at block 232 is delivered to the fuel cell system 10. The voltage of the fuel cell stack 12 is then controlled according to a cold or freeze startup strategy at block 220 to generate power at the fourth power output level.

The method 200 next moves on block 222, where it again is determined if the temperature of the fuel cell system 10, or more specifically a temperature of a coolant that is configured to cool the stack 12, is less than the first threshold. If the temperature of the fuel cell system 10, or more specifically the temperature of the coolant that is configured to cool the stack 12, is not less than the first threshold, the method 200 returns to block 214. If the temperature of the fuel cell system 10, or more specifically the temperature of the coolant that is configured to cool the stack 12, is less than the first threshold, the method 200 moves on to block 208, where the fuel cell system 10 is operated according to the standard or normal operation. The method 200 then moves on to block 210 where the startup sequence ends.

It should be understood that the flowchart in FIG. 3 is for illustrative purposes only and that the method 200 should not be construed as limited to the flowchart in FIG. 3. Some of the steps of the method 200 may be rearranged while others may be omitted entirely.

Another aspect of the concept disclosed herein may include delivering the surplus electricity from the fuel cell system 10 during the start sequence to a user's home (e.g., via the connection between the electrical port 142 and the connector head 144) to power the user's home during the cold start rather than delivering the power to a power grid.

In another aspect of the concept disclosed herein, a feature may be added to allow the user to preplan a startup, in cold weather, when the vehicle is connected to the charge port in an outdoor environment, where the fuel cell vehicle has a bi-directional charge port and a small coolant heater. The request from the customer for a future startup in the cold environment will trigger the scheduled pre-start procedure. When the pre-start procedure is initiated according to the schedule, the vehicle controls can check the temperatures of the fuel cell, battery, and cabin, and if the temperature is below a minimum threshold, the vehicle controls can enable power to be delivered from the grid power to run the heater and warm the fuel cell, battery, and cabin to a minimum threshold. The timing of the pre-start procedure could be determined based on the user's requested drive away time, the current temperatures of the fuel cell, battery, and cabin, and the capability of the onboard coolant heater, or similar device, to deliver heat.

In yet another aspect of the concept disclosed herein, the charge port 142 could provide a loss of service option that allows the user to charge the battery in lieu of current systems which prevent the battery from charging in the event the fuel cell becomes inoperable. If the fuel cell system is inoperable, the charge port could allow a customer to recharge as needed to get the vehicle to a service center.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
an electric machine configured to propel the vehicle;
a battery configured to provide electrical power to the electric machine;
a fuel cell configured to provide electrical power to the electric machine;
an electrical connector configured to connect the battery to an external source to charge the battery; and
a controller programmed to, in response to, (i) initiating a vehicle start sequence, (ii) a temperature of the fuel cell being less than a threshold, and (iii) the electrical connector being connected to the external source, (a) operate the fuel cell at a power output to increase the temperature of the fuel cell, (b) limit delivery of electrical power from the fuel cell to the electric machine to less than a commanded value, and (c) deliver power generated by the fuel cell to the external source.

2. The vehicle of claim 1, wherein the controller is further programmed to, in response to, (i) initiating the start sequence and (ii) the temperature of the fuel cell being greater than the threshold, deliver electrical power from the fuel cell to the electric machine at the commanded value.

3. The vehicle of claim 1, wherein the controller is further programmed to, in response to, (i) initiating the vehicle start sequence, (ii) the temperature of the fuel cell being less than the threshold, (iii) the electrical connector being disconnected from the external source, and (iv) a charging capacity of the battery being greater than a second threshold, (a) operate the fuel cell at a second power output that is less than the power output to increase the temperature of the fuel cell, (b) limit delivery of electrical power from the fuel cell to the electric machine to less than a commanded value, and (c) deliver power generated by the fuel cell to the battery.

4. The vehicle of claim 3, wherein the controller is further programmed to, in response to, (i) initiating the vehicle start sequence, (ii) the temperature of the fuel cell being less than the threshold, (iii) the electrical connector being disconnected from the external source, (iv) the charging capacity of the battery being less than the second threshold, and (v) an auxiliary load, (a) operate the fuel cell at a third power output that is less than the second power output to increase the temperature of the fuel cell, (b) limit delivery of electrical power from the fuel cell to the electric machine to less than the commanded value, and (c) deliver power generated by the fuel cell to the auxiliary load.

5. The vehicle of claim 4, wherein the controller is further programmed to, in response to, (i) initiating the vehicle start sequence, (ii) the temperature of the fuel cell being less than the threshold, (iii) the electrical connector being disconnected from the external source, (iv) the charging capacity of the battery being less than the second threshold, and (v) an absence of the auxiliary load, (a) operate the fuel cell a fourth power output that is less than the third power output to increase the temperature of the fuel cell and (b) limit delivery of electrical power from the fuel cell to the electric machine to less than the commanded value.

6. The vehicle of claim 1, wherein the external source is a power grid.

7. A vehicle comprising:
an electric machine configured to propel the vehicle;
a battery configured to provide electrical power to the electric machine;
a fuel cell configured to provide electrical power to the electric machine;
an electrical connector configured to engage and disengage a mating connector to connect and disconnect the battery to and from an external source, respectively; and
a controller programmed to,
in response to, (i) starting the vehicle, (ii) a temperature of the fuel cell being less than a first threshold, and (iii) the electrical connector engaging the mating connector, (a) operate the fuel cell at a first power output to increase the temperature of the fuel cell, and
in response to, (i) starting the vehicle, (ii) the temperature of the fuel cell being less than the first threshold, (iii) the electrical connector being disengaged from the mating connector, and (iv) a charging capacity of the battery being greater than a second threshold, operate the fuel cell at a second power output that is less than the power output to increase the temperature of the fuel cell.

8. The vehicle of claim 7, wherein the controller is further programmed to, in response to, operating the fuel cell at the first power output, deliver power generated by the fuel cell to the external source.

9. The vehicle of claim 7, wherein the controller is further programmed to, in response to, operating the fuel cell at the second power output, deliver power generated by the fuel cell to the battery.

10. The vehicle of claim 7, wherein the controller is further programmed to, in response to, (i) starting the vehicle, (ii) the temperature of the fuel cell being less than the first threshold, (iii) the electrical connector being disengaged from the mating connector, (iv) the charging capacity of the battery being less than the second threshold, and (v) an auxiliary load, operate the fuel cell at a third power output that is less than the second power output to increase the temperature of the fuel cell.

11. The vehicle of claim 10, wherein the controller is further programmed to, in response to, operating the fuel cell at a third power output, deliver power generated by the fuel cell to the auxiliary load.

12. The vehicle of claim 10, wherein the controller is further programmed to, in response to, (i) starting the vehicle, (ii) the temperature of the fuel cell being less than the first threshold, (iii) the electrical connector being disengaged from the mating connector, (iv) the charging capacity of the battery being less than the second threshold, and (v) an absence of the auxiliary load, operate the fuel cell at a fourth power output that is less than the third power output to increase the temperature of the fuel cell.

13. The vehicle of claim 7, wherein the external source is a power grid.

14. The vehicle of claim 7, wherein the external source is a power system of an adjacent building.

15. A vehicle comprising:
a battery configured to store electrical power;
a fuel cell configured to generate electrical power;
an electrical connector configured to connect the battery to an external source; and
a controller programmed to, in response to, (i) a temperature of the fuel cell being less than a threshold and (ii) the electrical connector being connected to the external source, (a) operate the fuel cell at a power output to increase the temperature of the fuel cell and (b) deliver power generated by the fuel cell to the external source.

16. The vehicle of claim 15, wherein the controller is further programmed to, in response to, (i) the temperature of the fuel cell being less than the threshold, (ii) the electrical connector being disconnected from the external source, and (iii) a charging capacity of the battery being greater than a second threshold, (a) operate the fuel cell at a second power output that is less than the power output to increase the temperature of the fuel cell and (b) deliver power generated by the fuel cell to the battery.

17. The vehicle of claim 16, wherein the controller is further programmed to, in response to, (i) the temperature of the fuel cell being less than the threshold, (ii) the electrical connector being disconnected from the external source, (iii) the charging capacity of the battery being less than the second threshold, and (iv) an auxiliary load, operate the fuel cell at a third power output that is less than the second power output to increase the temperature of the fuel cell.

18. The vehicle of claim 17, wherein the controller is further programmed to, in response to, (i) the temperature of the fuel cell being less than the threshold, (ii) the electrical connector being disconnected from the external source, (iii) the charging capacity of the battery being less than the second threshold, and (iv) an absence of the auxiliary load, operate the fuel cell at a fourth power output that is less than the third power output to increase the temperature of the fuel cell.

19. The vehicle of claim 15, wherein the external source is a power grid.

20. The vehicle of claim 15, wherein the external source is a power system of an adjacent building.
